(19) United States
(12) Patent Application Publication
(10) Pub. No.: US 2009/0134740 A1
(43) Pub. Date: May 28, 2009

(54) MOTOR AND FAN UNIT USING THE SAME

(75) Inventor: Kyouichi Okada, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/275,359

(22) Filed: Nov. 21, 2008

(30) Foreign Application Priority Data
Nov. 22, 2007 (JP) 2007-302940

(51) Int. Cl. H02K 1/12; F04D 25/08

(52) U.S. Cl. 310/216; 417/352

(57) ABSTRACT

A motor including a stator provided with a claw pole; and a rotor having a magnet confronting the stator; wherein the claw pole is magnetically asymmetrical.

### CROSS-REFERENCE TO RELATED APPLICATIONS

This application is based upon and claims the benefit of priority from the prior Japanese Patent Application 2007-302940, filed on, Nov. 22, 2007, the entire contents of which are incorporated herein by reference.

### FIELD

The present disclosure relates to a motor provided with a stator having a claw pole and a fan unit provided with such motor.

### BACKGROUND

Japanese Patent Publication 2005-45890 A (Reference 1) and 2007-129830 A (Reference 2) disclose a motor having a claw pole provided on the peripheral edge of the stator that protrudes axially and located along the periphery of the stator at constant interval. The stator has a single phase coil wound on it and magnetic pole occurs at the claw pole by controlling the energization of the coil. The rotor is provided with a magnet that confronts the stator. The magnetic attraction between the magnet and the claw pole causes rotation of the rotor.

The above described claw pole motor allows a single claw pole to be configured as a single magnetic pole. Thus, a multi-polar stator can be configured by simply providing a plurality of claw poles.

The coil provided at the stator of the above described motor, however, is single phase. Thus, rotational magnetic field cannot be generated by selectively energizing the coils, which can be done in motor having a 3-phase coil, for example. Hence, a claw pole motor requires efficient generation of starting torque for rotating the rotor by the magnetic attraction between the magnet and the claw pole.

### SUMMARY

The present disclosure provides a motor that facilitates generation of starting torque for rotating the rotor and that provides improved activation. The present disclosure also provides a fan unit using such motor.

A motor according to the present disclosure includes a stator provided with a claw pole; and a rotor having a magnet confronting the stator; wherein the claw pole is magnetically asymmetrical.

The claw pole according to the above described configuration is magnetically asymmetrical. Thus, the steady position of the rotor relative to the stator goes forward in the rotational direction of the rotor as compared to a magnetically symmetrical claw pole. The rotor thus being allowed to rotate with greater ease can readily generate starting torque for rotating the rotor and improve activation.

The claw pole of the motor according to the present disclosure may be configured to be circumferentially asymmetrical. The claw pole may further be radially asymmetrical.

The fan unit of the present disclosure includes a motor and a fan rotated by the motor. The motor is provided with a stator having a claw pole and a rotor having a magnet that confronts the stator. The claw pole is configured to be magnetically asymmetrical.

According to the above described configuration, starting torque for rotating the fan can be generated with greater ease to improve activation.

### BRIEF DESCRIPTION OF THE DRAWINGS

Other objects, features and advantages of the present disclosure will become clear upon reviewing the following description of the exemplary embodiments with reference to the accompanying drawings, in which,

FIG. 1 is a vertical cross sectional side view of a base taken along line F1-F1 of FIG. 2 according to a first exemplary embodiment of the present disclosure,

FIG. 2 is a perspective view generally depicting the overall configuration of a fan unit;

FIG. 3 is a vertical cross sectional view of the fan unit;

FIG. 4 is a perspective view of the base and a stator;

FIG. 5 is a bottom view of the fan unit;

FIG. 6 is a perspective view of the base and the stator according to a second exemplary embodiment of the present disclosure,

FIG. 7 is a plan view of the base and the stator;

FIG. 8 corresponds to FIG. 6 and depicts a third exemplary embodiment of the present disclosure; and

FIG. 9 corresponds to FIG. 3.

### DETAILED DESCRIPTION

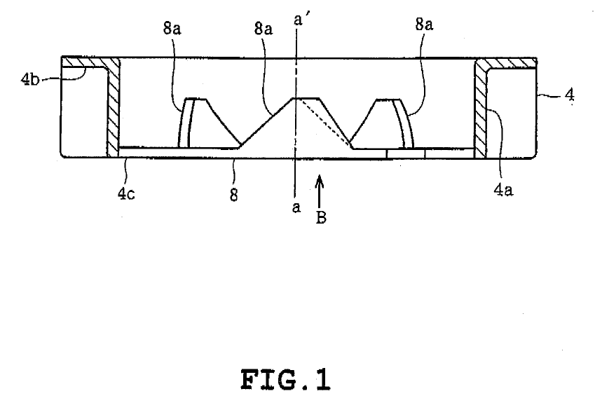

A first exemplary embodiment of the present disclosure will be described with reference to FIGS. 1 to 5.

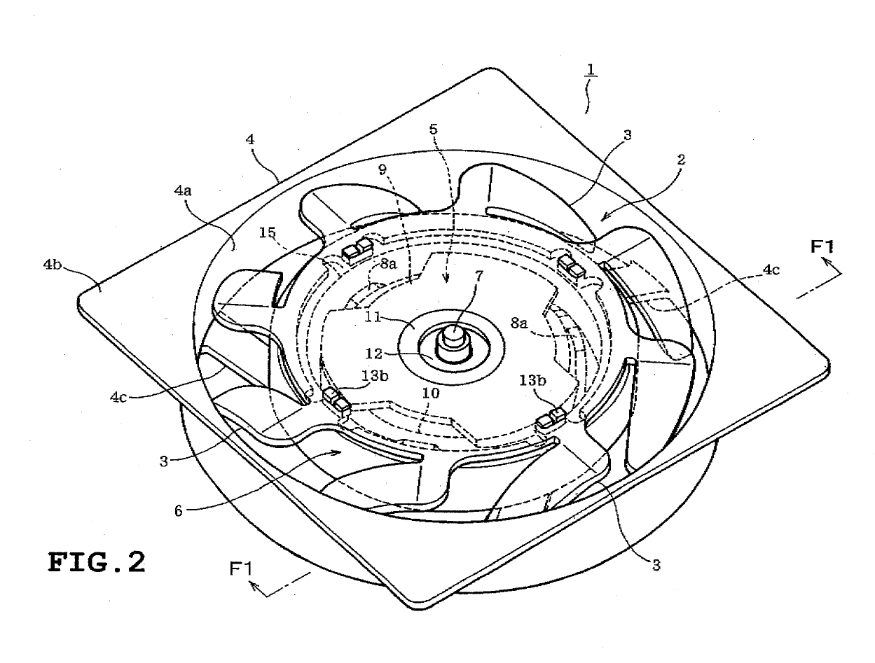

FIG. 2 describes a fan unit 1 comprising a motor 2 and a fan 3 rotated by motor 2. Fan unit 1 has a base 4 that receives a cylindrical waist 4a. On one axial end of cylindrical waist 4a, a rectangular flange is provided that protrudes toward the outer periphery of waist 4a. Waist 4a contains a stator 5 and a rotor 6 which are main components of motor 2. Stator 5 is disc shaped and centers on a shaft 7. Rotor 6 rotates counterclockwise about shaft 7 so as to rotate around the outer periphery of stator 5.

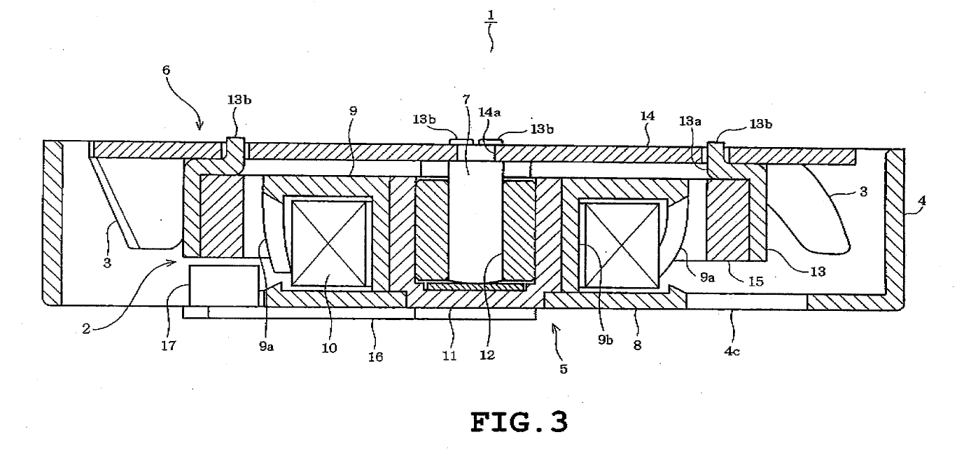

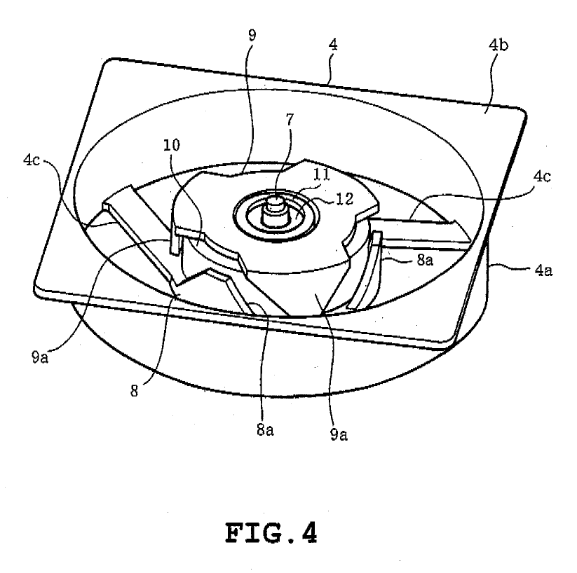

As can be seen also in FIGS. 3 and 4, stator 5 comprises a circular stator yoke 8 and a stator yoke 9 also circular in form and having a cylindrical portion 9b in its central portion. Stator yoke 8 is provided integrally with a plurality (3, in this case) of arms 4c that extend radially inward from the other axial end (the lower end as viewed in FIGS. 3 and 4) of waist 4a. Stator yoke 9, on the other hand, is disposed so as to axially confront stator yoke 8 over cylindrical portion 9b.

Some portions of the peripheral edge of stator yoke 8 are bent in the axial direction (upward as viewed in the drawings) to define a plurality (3, in the present exemplary embodiment) of axially protruding claw poles 8a provided integrally with stator yoke 8. Likewise, some portions of the peripheral edge of stator yoke 9 are bent in the axial direction (downward as viewed in the drawings) to define a plurality (3, in the present exemplary embodiment) of axially protruding claw poles 9a provided integrally with stator yoke 9. Claw poles 8a and 9a are disposed at a constant peripheral interval respectively. Claw poles 8a and 9a are arranged so as to intermesh over a predetermined gap.

Stator 5 contains a single phase coil 10 wound circumferentially around cylindrical portion 9b of stator yoke 9. Stator 5 also has a bearing housing 11 affixed at its center, more specifically at the center of base 4 (stator yoke 8) by way of press fit, bonding, or the like. Bearing housing 11 is fitted into cylindrical portion 9b of stator yoke 9. Bearing housing 11 houses a bearing 12 which is affixed by way of press fit, or the like. Shaft 7 is inserted into bearing 12 so as to be rotatable circumferentially.

Rotor 6 comprises a rotor yoke 13 made of magnetic material (by metal such as iron, for example) and rotor yoke 14 made of non-magnetic material (such as non-magnetic metal, resin, and plastic). Rotor yoke 13 is annular in form and has a round top opening 13a. Along the inner circumference of rotor yoke 13, an annular magnet 15 is disposed which has N-poles and S-poles alternately provided on it. Rotor yoke 14, on the other hand, is disc shaped and has a shaft slot 14a penetrating through its center. Formed integrally along the peripheral edge 14 of rotor yoke 14 is a plurality (8, in the present exemplary embodiment) of fans 3 that are bent downward.

Rotor 6 is an integral assembly of rotor yokes 13 and 14 which are joined by caulking a protrusion 13b that edges opening 13a. The upper end of shaft 7 is secured in shaft slot 14a of rotor 6 (rotor yoke 14) to allow rotor 6 (rotor yoke 13 and 14) to rotate around the outer periphery of stator 5. Magnet 15 is situated in confrontation with the outer peripheral surface of stator 5 (claw pole 8a and 9a).

The portion of rotor 6 proximal to magnet 15 is configured by rotor yoke 13 made of magnetic material while the rest of rotor 6 is configured by rotor yoke 14 made of non-magnetic material. Thus, magnetic flux of magnet 15 flows efficiently in listed sequence of: claw pole 8a (9a), stator yoke 8 (9), stator yoke 9 (8) and claw pole 9a (8a), with less susceptibility of leaking toward rotor yoke 14.

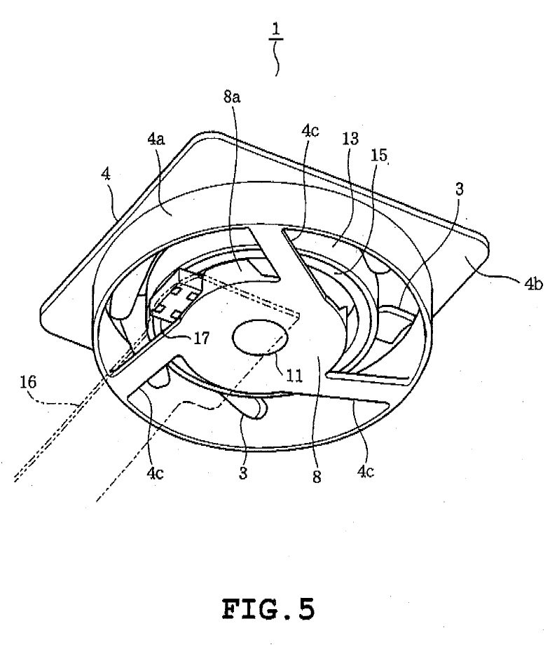

Referring now to FIG. 5, on the bottom surface of fan unit 1, a circuit board 16 is mounted that is connected to a control circuit not shown. Circuit board 16 has magnet sensor 17, implemented on a portion in confrontation with magnet 15, for detecting the magnetism of magnet 15. The control circuit detects the rotational position of rotor 6 based on the detection signal transmitted from magnet sensor 17 to control the energization of coil 10 based on the detection.

The shapes of claw poles 8a and 9a will be described hereinafter with reference to FIG. 1. FIG. 1 is a vertical cross sectional side view of base 4 taken along line F1-F1 of FIG. 2. FIG. 1 is a radial view of claw pole 8a.

A portion of claw pole 8a, as viewed in the radial direction, expands in the direction of rotation of rotor 6. This is shown in FIG. 1 as the tip of claw pole 8a being expanded toward the direction or rotation, in this case, the right side as viewed in FIG. 1. Claw pole 8a, thus exhibits a generally trapezoidal shape having opposing peripheral ends that are different in length and angle. Stated differently, claw pole 8a is circumferentially asymmetrical to center line a-a′, in which the portion situated in the direction of rotation relative to center line a-a′ is larger than its counterpart in the opposite side of center line a-a′. Center line a-a′ extends vertically and axially so as to circumferentially bisect the base portion of (the lower portion in FIG. 1) of claw pole 8a.

Though not shown in FIG. 1, claw pole 9a is similar in shape to claw pole 8a, exhibiting a generally trapezoidal shape with its tip being expanded toward the direction of rotation, in this case, the right side as viewed in FIG. 1 to exhibit a circumferentially asymmetrical profile.

The operation and effect of the present exemplary embodiment will be described hereinafter with reference to FIG. 1.

Generally, when a claw pole is configured to be circumferentially symmetrical to center line a-a′ as shown in broken line in FIG. 1, magnetic pole occurs at the center (at center line a-a′) by the energization of coil 10.

As opposed to this, the present exemplary embodiment configures claw pole 8a to be circumferentially asymmetrical. Thus, magnetic pole occurs at a location slightly advanced towards the direction of rotation of rotor 6 from center line a-a′, which may be indicated by arrow B. By configuring claw pole 8a to be circumferentially asymmetrical, location of magnetic pole occurring at claw pole 8a is displaced circumferentially in the direction of rotation of rotor 6, thus rendering claw pole 8a magnetically asymmetrical.

The location of magnetic pole of claw poles 8a and 9a being circumferentially displaced causes the magnetic pole (either N or S pole) of magnet 15 to be attracted to a circumferentially displaced location. This slightly advances the steady position of rotor 6 relative to stator 5 in the direction of rotation of rotor 6, thus facilitating the rotation of rotor 6 and suppressing occurrence of dead points that prohibit rotor 6 activation even when coil 10 is energized.

The above configuration facilitates generation of start-up torque for rotating rotor 6 (fan 3) to improve the activation of fan unit 1.

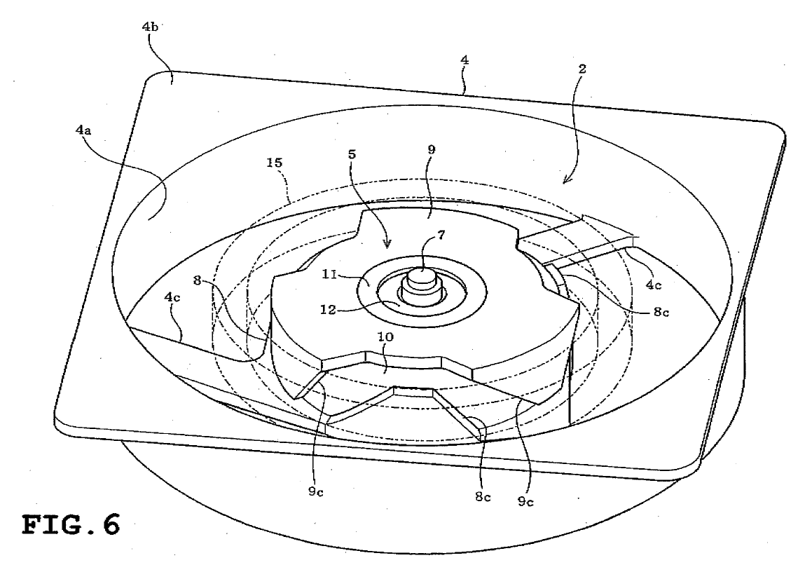

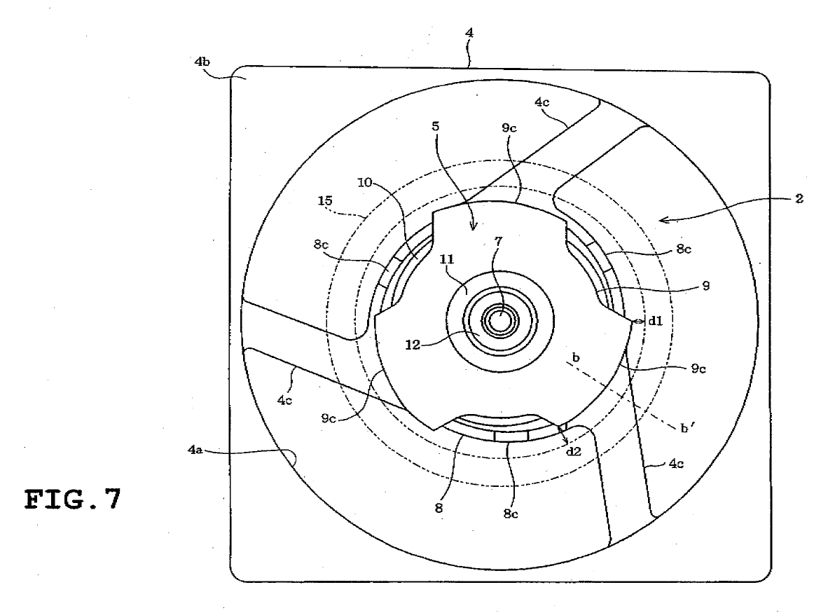

Next, a second exemplary embodiment will be described with reference to FIGS. 6 and 7. In FIGS. 6 and 7, the only component of rotor 6 shown is the image of magnet 15 represented by double dot chain line. Description will only be given hereinafter on portions that differ from the first exemplary embodiment.

In the second exemplary embodiment, claw pole 8c of stator yoke 8 and claw pole 9c of stator yoke 9 respectively differs from claw pole 8a and claw pole 9a of the first exemplary embodiment.

One circumferential end of claw pole 9c (the end situated in the direction of rotation of rotor 6), when viewed in the axial direction, expands radially as compared to the opposite end (the end situated opposite the direction of rotation of rotor 6). As can be seen in FIG. 7, distance d1 between one end of claw pole 9c and magnet 15 is less than distance d2 between the other end of claw pole 9c and magnet 15. In other words, the outer peripheral surface of claw pole 9c is placed in closer proximity to magnet 15 as it gets closer to the leading portion of rotation. Claw pole 9c is configured to be radially asymmetrical such that the portion situated in the direction of rotation relative to a center line b-b′ is larger than its counterpart in the opposite side of center line b-b′. Center line b-b′ extends radially and horizontally so as to circumferentially bisect the base portion of claw pole 9c.

Likewise, claw pole 8c is configured to be radially asymmetrical to a center line (not shown) extending radially and horizontally that circumferentially bisects the base portion of claw pole 8c. Both claw poles 8c and 9c, when viewed in the radial direction, exhibits a generally trapezoidal shape with their tips being expanded toward the direction or rotation of rotor 6 as described and shown in claw poles 8a and 9a of the first exemplary embodiment. That is, claw pole 8c and 9c are configured asymmetrical in both radial and axial directions.

Next, a description will be given on the operation of the present exemplary embodiment.

Claw poles 8c and 9c are configured radially asymmetrical as described above. Thus, magnetic attraction between magnet 15 and claw pole 8c and 9c increases toward the direction of rotation which is the direction to approximate magnet 15, consequently rendering the claw poles 8c and 9c magnetically asymmetrical.

Thus, magnetic pole (N-pole or S-pole) of magnet 15 is attracted to a circumferentially displaced location (location displaced toward the rotational direction of rotor 6). As a result, the steady position of rotor 6 relative to stator 5 is advanced toward the direction of rotation or rotor 6 to facilitate the rotation of rotor 6.

In the present exemplary embodiment, claw poles 8c and 9c are configured circumferentially asymmetrical as well. Thus, magnetic pole of magnet 15 is attracted to a circumferentially displaced location (location displaced toward the rotational direction of rotor 6) as in the first exemplary embodiment, thereby increasingly facilitating the rotation of rotor 6.

The above configuration facilitates generation of starting torque for rotation of rotor 6 to improve the activation of fan unit 1.

Claw poles 8c and 9c being configured radially and circumferentially asymmetrical in the present exemplary embodiment may be configured to be only radially asymmetrical instead.

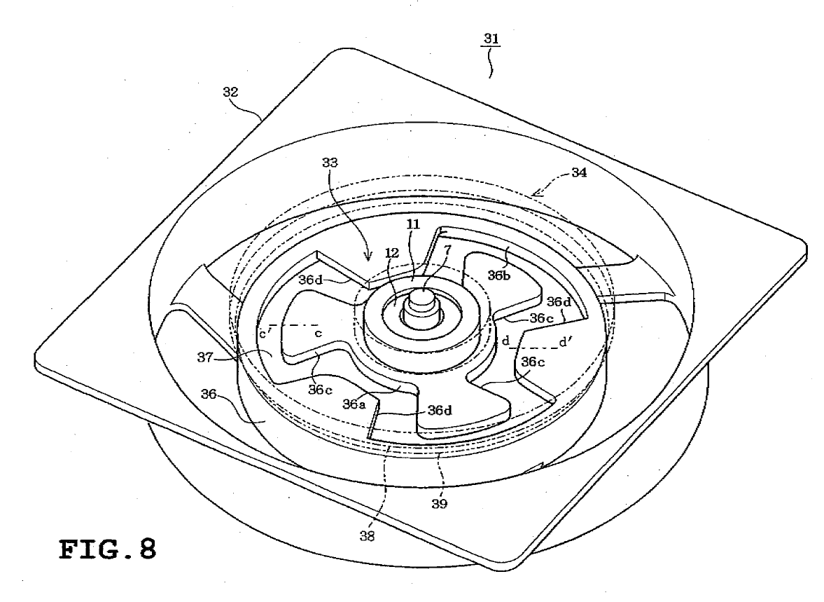

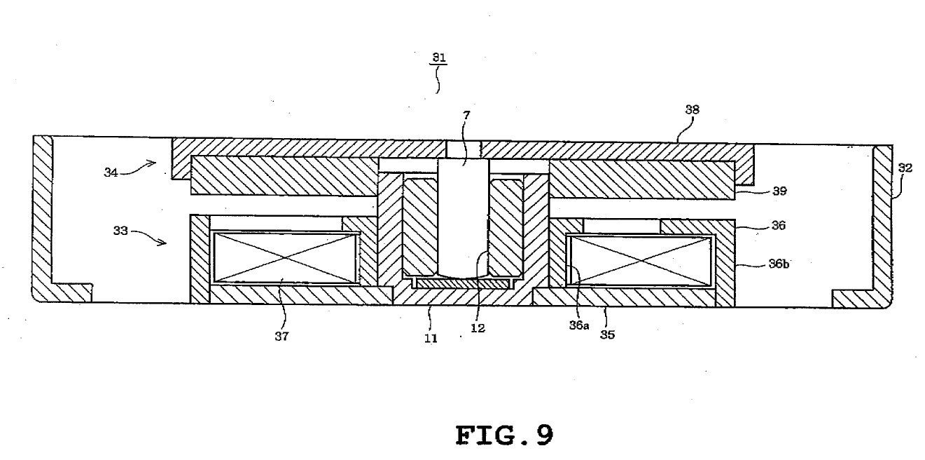

Next, a third exemplary embodiment of the present disclosure will be described with reference to FIGS. 8 to 9. The image of rotor 34 is shown in double dot chain line in FIG. 8. Identical reference symbols will be used to represent elements that are identical to the first exemplary embodiment and a description will be given only on elements that differ.

Motor 31 according to the third exemplary embodiment takes an axial gap configuration. Motor 2 described in the first exemplary embodiment is a radial gap motor. Motor 31 has a base 32 provided with as generally flat stator 33 on its central portion that centers on shaft 7. A generally flat rotor 34 is provided above stator 33 so as to be rotatable counterclockwise about shaft 7.

Stator 33 comprises a stator yoke 35 (refer to FIG. 9) instead of the earlier described stator yoke 8, and a stator yoke 36 including an inner cylindrical portion 36a and an outer cylindrical portion 36b and covering the upper portion of stator yoke 35. On the upper surface of stator yoke 36, a plurality (3, in the present exemplary embodiment) of claw poles 36c is formed integrally on the upper end of inner cylindrical portion 36a whereas a plurality (3, in the present exemplary embodiment) of claw poles 36d is formed integrally on the upper end of the outer cylindrical portion 36b as can be seen in FIG. 8. Claw poles 36c and 36d are disposed at predetermined circumferential intervals so as to intermesh over a predetermined gap. Stator 33 contains a single phase coil 37 instead of the earlier described coil 10. Coil 37 being generally flat compared to coil 10 is wound on inner cylindrical portion 36a.

Rotor 34 comprises a rotor yoke 39 and a magnet 39 mounted integrally on its under side. Magnet 39 confronts the upper surface of stator 33, in other words, claw poles 36c and 36d.

Next the shapes of claw pole 36c and 36d will be described with reference to FIG. 8.

Claw pole 36c is generally are shaped and expands outward from the upper end of inner cylindrical portion 36a. One circumferential end (the end situated in the direction of rotation of rotor 34) of claw pole 36c protrudes so as to be gradually narrowed toward the direction of rotation. In other words, the portion of claw pole 36c situated in the direction of rotation relative to a center line c-c′ is pointed as compared to the portion in the opposite side relative to the direction of rotation such that claw pole 36c, overall, is circumferentially asymmetrical. Center line c-c′ extends radially and horizontally so as to circumferentially bisect the base portion of claw pole 36c.

Claw pole 36d is generally shaped into a trapezoid and expands inward from the upper end of outer cylindrical portion 36b. One circumferential end (the end situated in the direction of rotation of rotor 34) of claw pole 36d extends toward the direction of rotation of rotor 34. One end of craw pole 36d is configured angularly where as the other end (situated in the direction opposite the direction of rotation of rotor 34) is smoothly rounded. In other words, the portion of claw pole 36d situated in the direction of rotation relative to a center line d-d′ covers greater area as compared to the portion in the opposite side relative to the direction of rotation such that claw pole 36d, overall, is circumferentially asymmetrical. Center line d-d′ extends radially and horizontally so as to circumferentially bisect the base portion of claw pole 36d.

Claw poles 36c and 36d of the third exemplary embodiment are configured circumferentially asymmetrical. Thus, the location of magnetic poles occurring at claw poles 36c and 36d are circumferentially displaced in the direction of rotation of rotor 34 rendering the claw poles 36c and 36d magnetically asymmetrical. The above configuration also slightly advances the location of steady position of rotor 34 relative to stator 33 towards the direction of rotation of rotor 34. Thus, generation of starting torque for rotating rotor 34 can be facilitated to improve the activation of motor 31.

The present disclosure is not limited to the above described exemplary embodiments but may be modified or expanded as follows.

Not all of the plurality of claw poles 8a and 9a, (8c and 9c), and (36c and 36d) need to be configured asymmetrical. Alternative configuration may be employed in which at least one of the plurality of claw poles is configured asymmetrical.

A protrusion may be provided on a portion of claw poles 8a and 9a, (8c and 9c), and (36c and 36d), for example on a portion located in the direction of rotation relative to the center line to render claw poles 8a and 9a, (8c and 9c), and (36c and 36d) circumferentially or radially asymmetrical.

As described above, by providing claw poles 8a and 9a, (8c and 9c), and (36c and 36d) integrally with base 4 (32) and/or providing fan 3 integrally with rotor 6, motors 2 and 31 can be reduced in size and thickness. Such configuration allows a fan unit to be downsized to 10 mm×10 mm.

The present disclosure is not limited to application to the above described motor 2 (fan unit 1) of outer rotor type or motor 31 of axial gap type, but may also be applied to inner rotor motors having a rotor provided on the inner periphery of the stat or.

The foregoing description and drawings are merely illustrative of the principles of the present disclosure and are not to be construed in a limited sense. Various changes and modifications will become apparent to those of ordinary skill in the art. All such changes and modifications are seen to fall within the scope of the disclosure as defined by the appended claims.

What is claimed is:

1. A motor, comprising:
a stator provided with a claw pole; and
a rotor having a magnet confronting the stator;
wherein the claw pole is magnetically asymmetrical.

2. The motor according to claim 1, wherein the claw pole is configured circumferentially asymmetrical.

3. The motor according to claim 1, wherein the claw pole is configured radially asymmetrical.

4. A fan unit, comprising:
a motor; and
a fan rotated by the motor;
wherein the motor includes a stator provided with a claw pole, a rotor having a magnet confronting the stator; and wherein the claw pole is magnetically asymmetrical.

5. The fan unit according to claim 4, wherein the claw pole of the motor is configured circumferentially asymmetrical.

6. The fan unit according to claim 4, wherein the claw pole of the motor is configured radially asymmetrical.
